(19) United States
(12) Patent Application Publication
(10) Pub. No.: US 2024/0318461 A1
(43) Pub. Date: Sep. 26, 2024

(54) Adjustable Striker Plate

(71) Applicant: KDINC, LLC, Robstown, TX (US)

(72) Inventor: Brian Eugene Mitchell, Robstown, TX (US)

(21) Appl. No.: 18/124,246

(22) Filed: Mar. 21, 2023

Related U.S. Application Data
(60) Provisional application No. 63/372,555, filed on Mar. 22, 2022.

(51) Int. Cl. E05B 15/02

(52) U.S. Cl. CPC E05B 15/024; E05B 2015/0275

(57) ABSTRACT

This invention relates to improvements in locks and latches, particularly improving the strike plate, allowing horizontal and vertical adjustments to compensate for changes in the positioning of the strike plate relative to the heel of the latch bolt when the door is seated against the stop. The invention relates to an adjustable strike plate for locks, latches, and deadbolts, enables quick adjustment of a strike plate, and ensures holding the plate securely in an adjusted position. The invention is an apparatus made of three plates with two different sets of screws, one for securing the apparatus to a door jamb and another for adjusting and aligning the striker plate to a latch and/or deadbolt.

### CROSS-REFERENCE TO RELATED APPLICATIONS

This Nonprovisional Application claims benefit to prior U.S. provisional applications No. 63/472,555 filed on 22 Mar. 2022.

### STATEMENT REGARDING FEDERALLY SPONSORED RESEARCH OR DEVELOPMENT

Not applicable.

The present disclosure relates to adjustable lock strike plates to align door frames to a latch and/or deadbolt.

### BACKGROUND

Lock strike plates frequently require adjusting and repositioning on a door frame due to shrinking or sagging of the door, perhaps caused by climate changes or settling of the foundation that changes the position of the door jamb in relation to the door latch. The alignment of the door latch to the door jamb cavity may become insufficient to secure the door to the door jamb. One of the most difficult and time-consuming tasks associated with installing a door lock or latch is aligning the door latch with the door strike. Misalignment between the latch and the door strike prevents the door from being latched and locked.

In many applications, repositioning the latch is difficult, if not impossible, once the latch has been positioned on the door. Similarly, many door frames come with pre-fabricated slots for mounting the door strike, making it difficult to adjust the position of the door strike. If the door latch and strike are misaligned, the installer is typically required to machine or file a portion of the strike to accept the latch. The installation can therefore be time-intensive, expensive, and visually unappealing.

For many reasons, different types of adjustable strike plates have been proposed but have yet to prove impractical because of excessive cost due to a complicated structure, failure to reach the desired adjustment, or failure of the strike plate to maintain adjustment. All these issues are overcome with this invention which costs the same or less to manufacture than the conventional or industry-standard strike plate, can be adjusted in seconds, and holds the adjustment rigidly and permanently with conventional or industry-standard fastening screws and retaining devices that are held interlocked to the strike plate and the door assembly.

### BRIEF DESCRIPTION OF THE INVENTION

The main objective of the invention is to provide a simple and practical structure for extremely fine adjustments of the strike plate, both horizontal and vertical, to any extent that can be done easily, and the plate is held firmly after adjustment without the possibility of shifting from the correct alignment.

Another purpose of the invention is to provide a strike plate that costs practically no more to manufacture and install than the conventional or industry-standard non-adjustable strike plate and which can be successfully applied to locks already installed.

Further objectives of the invention are providing a strike plate that can be positioned on the left or right of a door frame, one that is held in place by conventional or industry-standard screws, and the existing screw openings are used for holding the plate in any position of adjustment.

The invention provides a strike plate that is adjustable at will to compensate for inaccurate positioning associated with swelling or shrinking of the door or jamb; settling of the foundation that changes the position of the door jamb in relation to the door latch; provides a strike plate as outlined which can be adjusted at will for variations occurring after initial adjustments have been made; and provide a strike plate that is economical to manufacture, easy to install and adjust.

In some aspects, the techniques described herein relate to an adjustable striker plate apparatus including an inner plate, a middle plate, an outer plate, and two sets of screws, a first screw set and a second screw set, wherein the inner plate includes one central rectangular hollow gap, one top circular hole, and one bottom hole; wherein the middle plate includes one central rectangular hollow gap with a top and bottom hollow indentation, a top right hole, a top left hole, a bottom right hole, a bottom left hole, a right rectangular perpendicular protuberance, a top perpendicular protuberance, left perpendicular protuberance, a bottom perpendicular protuberance; wherein the outer plate includes one central rectangular hollow gap, one top circular hole, one bottom hole, and one semi-circular protuberance, wherein the three plates are placed parallel to each other, forming a central rectangular apparatus-cavity by the inner plate gap, the middle plate gap, and the outer plate gap; and wherein the apparatus is detachably attached to a door jamb of a doorframe.

In some aspects, the techniques described herein relate to an apparatus, wherein the inner plate is placed next to the door jamb, the middle plate is sandwiched between the inner plate and the outer plate, and the outer plate is placed and resides over the middle plate.

In some aspects, the techniques described herein relate to an apparatus, wherein the middle plate is secured over the inner to the door jamb with the first screw set, for example, four #6×1.25 screws.

In some aspects, the techniques described herein relate to an apparatus, wherein the first screw set includes four #6×1.25 screws and the four screws fit into the four corners of the middle plate.

In some aspects, the techniques described herein relate to the apparatus, wherein the first screw set ensures greater security and stability than a typical strike plate installation.

In some aspects, the techniques described herein relate to an apparatus, wherein the outer plate is placed and resides over the middle plate through the holes of the middle plate with the second screw set, for example, two #6-32 screws.

In some aspects, the techniques described herein relate to the apparatus, wherein the two screws from the second screw set, when offset, the outer plate allows a greater range of motion both horizontally and vertically for alignment adjustment.

In some aspects, the techniques described herein relate to the apparatus, the middle plate, together with the outer plate, conceal the inner plate.

In some aspects, the techniques described herein relate to an apparatus, the first screw set are longer wood screws into the door jamb for heavier/stronger security and stability.

In some aspects, the techniques described herein relate to an apparatus, the apparatus is installed into a doorframe pre-fabricated cavity by increasing the depth by 5/16″ (inches) to facilitate the deeper middle plate and adjustable inner plate assembly.

In some aspects, the techniques described herein relate to an apparatus, the apparatus is reversible and is mountable on all and any sides of a doorframe, for example, the left or right side of the doorframe.

In some aspects, the techniques described herein relate to an apparatus, where the apparatus is substitutable/replaceable for a conventional strike plate, for example, an industry standard, a conventional industrial or residential strike plate.

In some aspects, the techniques described herein relate to an apparatus, wherein the apparatus is a substitutable/replacement for any conventional or industry-standard latch plate.

In some aspects, the techniques described herein relate to an apparatus, wherein the apparatus is a substitutable/replacement for any conventional or industry-standard deadbolt plate.

In some aspects, the techniques described herein relate to the method of installing an adjustable striker plate apparatus including an inner plate, a middle plate, an outer plate, and two sets of screws, a first screw set and a second screw set, wherein the inner plate includes one central rectangular hollow gap, one top circular hole, and one bottom hole; wherein the middle plate includes one central rectangular hollow gap with a top and bottom hollow indentation, a top right hole, a top left hole, a bottom right hole, a bottom left hole, a right rectangular perpendicular protuberance, a top perpendicular protuberance, left perpendicular protuberance, a bottom perpendicular protuberance; wherein the outer plate includes one central rectangular hollow gap, one top circular hole, one bottom hole, and one semi-circular protuberance, wherein the three plates are placed parallel to each other forming a central rectangular apparatus-cavity by the inner plate gap, the middle plate gap, and the outer plate gap; and wherein the apparatus is detachably attached to a door jamb of a doorframe, and the method includes of steps: (i) positioning the door adjustment inner plate on the door jamb cavity, (ii) the middle plate is placed over the inner plate and secured with four #6×1.25 wood screws, wherein the middle plate is secured non-adjustable to the door jamb over the latch and/or deadbolt cavities, (iii) the outer plate is placed and resides over the middle plate secured into the inner plate, with two screws (#6-32 screws), aligning the strike plate with the door jamb cavity, (iv) the outer plate is placed over the middle plate and the door jamb, wherein the outer plate is sized to be slightly smaller than the door jamb cavity, and (v) after proper alignment, the outer plate is secured by two #6-32 screws.

In some aspects, the techniques described herein relate to a method, wherein the inner plate attachment to the door jamb limits the positioning of a latch or deadbolt opening to the apparatus cavity.

In some aspects, the techniques described herein relate to a method, the outer plate allows vertical or horizontal adjustments over the door jamb cavity.

In some aspects, the techniques described herein relate to a method, the door jamb cavity is deepened by 5/16″, and positions the inner plate into the cavity.

In some aspects, the techniques described herein relate to a method, wherein before tightening #6-32 screws, an installer ensures proper alignment between the latch assembly and latch opening or cavity.

In some aspects, the techniques described herein relate to a method, where before tightening the #6-32 screws, an installer ensures proper alignment between a deadbolt assembly and a deadbolt opening.

### BRIEF DESCRIPTION OF THE FIGURES

FIG. 1 is an exploded isometric view and parts identification table for the adjustable striker plate assembly.

FIG. 2 is a collection of the back, left, front, right and bottom views of the assembled adjustable striker plate.

FIG. 3 is an exploded isometric front view of the adjustable striker plate assembly.

FIG. 4 is an exploded isometric rear view of the adjustable striker plate assembly.

FIG. 5 is a flowchart of an example method for installing and using an adjustable striker plate apparatus.

FIG. 6 is an exploded isometric view with dimensions for the apparatus parts.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments and various aspects of the present disclosure. It will be apparent to those skilled in the art that specific details need not be employed, that example embodiments may be embodied in many different forms, and that neither should be construed to limit the scope of the disclosure. In some example embodiments, well-known processes, device structures, and technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments or aspects, will be better understood when read in conjunction with the appended figures. As used herein, an element or step recited in the singular and proceeded with the word “a” or “an” should be understood as not excluding the plural of said elements or steps unless such exclusion is explicitly stated. Furthermore, references to “one embodiment,” “an embodiment,” “one aspect,” or “an aspect” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

The invention provides an adjustable strike mounting system that allows for positional adjustment of the adjustable strike. In particular, the design provides a straightforward solution to install and maintain and provides a unique ability to move the strike both horizontally and vertically for proper alignment with the door jamb cavity.

In some aspects, the techniques described herein relate to an adjustable striker plate apparatus including an inner plate, a middle plate, an outer plate, and two sets of screws, a first screw set and a second screw set, wherein the inner plate includes one central rectangular hollow gap, one top circular hole, and one bottom hole; wherein the middle plate includes one central rectangular hollow gap with a top and bottom hollow indentation, a top right hole, a top left hole, a bottom right hole, a bottom left hole, a right rectangular perpendicular protuberance, a top perpendicular protuberance, left perpendicular protuberance, a bottom perpendicular protuberance; wherein the four middle plate perpendicular protuberances form a middle-plate cavity; wherein the outer plate includes one central rectangular hollow gap, one top circular hole, one bottom hole, and one semi-circular protuberance, wherein the three plates are placed parallel to each other, forming a central rectangular apparatus-cavity by the inner plate gap, the middle plate gap, and the outer plate gap; and wherein the apparatus is detachably attached to a door jamb of a doorframe.

In some aspects, the techniques described herein relate to an apparatus, wherein the inner plate is placed next to the door jamb, the middle plate is sandwiched between the inner plate and the outer plate, and the outer plate is placed and resides over the middle plate.

In some aspects, the techniques described herein relate to an apparatus, wherein the outer plate has a semi-circular protuberance [9], wherein the protuberance is bent toward the inner plate, middle, or a door frame. The angle between the semi-circular protuberance [9] and the outer plate [2] is equal or less than 180 degrees, for example, 0, 1, 2, 3, 4, 5, 10, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95, 100, 105, 110, 115, 120, 125, 130, 135, 140, 145, 150, 155, 160, 165, 170, 175, 180, etc.

In some aspects, the techniques described herein relate to the apparatus, the middle plate, together with the outer plate, conceal the inner plate.

In some aspects, the techniques described herein relate to an apparatus, wherein the middle plate is secured over the inner plate to the door jamb with the first screw set, including four #6×1.25 screws. However, fewer or more screws, such as 2, 3, 4, 5, 6, 7, 8, etc, may be used. These screws may be customized to any door jamb and door frame.

In some aspects, the techniques described herein relate to an apparatus, wherein the first screw set includes four #6×1.25 screws and wherein the four screws fit into the four corners of the middle plate.

In some aspects, the techniques described herein relate to the apparatus, wherein the first screw set ensures greater security than a typical strike plate installation.

In some aspects, the techniques described herein relate to an apparatus, wherein the outer plate is placed and resides over the middle plate through the holes of the middle plate with the second screw set, including two #6-32 screws. However, fewer or more screws, such as 1, 2, 3, 4, 5, 6, 7, 8, etc, may be used. These screws may be customized to any door jamb and door frame.

In some aspects, the techniques described herein relate to an apparatus, the first screw set are longer wood screws into the door jamb for heavier/stronger security.

In some aspects, the techniques described herein relate to an apparatus, the apparatus is installed into a doorframe pre-fabricated cavity by increasing the depth by 5/16″(inches) to facilitate the deeper middle plate and adjustable inner plate assembly.

In some aspects, the techniques described herein relate to an apparatus, the screws from the first and/or second screw set may be made of wood, steel, metals, metal alloys, plastic, etc., and any combination thereof.

With this invention, the strike plate is reversible and may be fastened to a door frame without changing the relation or function of the parts. The strike plate may be substituted for a conventional or industry-standard strike plate without the necessity of providing new openings for the attaching screws since the same openings serve for holding the plate in position. The strike plate can be stamped and manufactured for the same cost, and the interlocking retaining parts can be formed from standard stock material without adding anything appreciable to the manufacturing cost. The strike plate can be applied to a door frame and secured in position as easily and quickly as a conventional or industry-standard plate while permitting quick adjustment from time to time, as variations in the door or frame may require.

In some aspects, the techniques described herein relate to an apparatus, the apparatus is reversible and is mountable on either side of the doorframe. The doorframe may be conventional, industry-standard, custom-made, or a combination of both.

In some aspects, the techniques described herein relate to an apparatus, where the apparatus is substitutable for a conventional or industry-standard strike plate. However, it may be with a customized strike plate.

In some aspects, the techniques described herein relate to an apparatus, wherein the apparatus is a replacement for any conventional or industry-standard latch plate.

In some aspects, the techniques described herein relate to an apparatus, wherein the apparatus is a replacement for any conventional or industry-standard deadbolt plate.

In some aspects, the techniques described herein relate to an apparatus, the apparatus or parts of the apparatus may be made of any durable metal/s, metal alloy/s, and other materials, for example, steel, iron, nickel, copper, zinc, die-cast zinc, chrome, silver, aluminum, tin, brass, bronze, aged bronze, fiberglass, laminate, plastics, rubber, wood, and any combination thereof.

In some aspects, the techniques described herein relate to an apparatus, the apparatus or parts thereof may be made using molds, 3-D printing, or both.

When installed, the invention door adjustment type A [1] is secured non-adjustable to the door jamb over the latch and/or deadbolt cavities. However, the positions of latch or deadbolt openings to the cavity are determined by the position of the inner slide [3] attached to the strike plate. In particular, the adjustable striker plate assembly is sized to be slightly smaller than the cavity. The installation allows the adjustable strike plate [2] position to be adjusted in the vertical or horizontal direction within the door jamb cavity.

During installation, an installer deepens the door jamb cavity by 5/16″ (inches) and positions the door adjustment inner slide [3] into the cavity. The door adjustment strike type A (1) is placed over the door adjustment inner slide [3] and secured with four wood screws [4].

In some aspects, the techniques described herein relate to an apparatus, the door jamb cavity may be deepened by up to 1″, for example, 0.1, 0.2, 0.25, 0.26. 0.27, 0.28, 0.29, 0.3, 0.31, 0.32, 0.33, 0.34, 0.35, 0.4, 0.45, 0.5, 0.55, 0.6, 0.7, 0.8, 0.9, 1, etc. in inches.

In some aspects, the techniques described herein relate to the apparatus, wherein the two screws from the second screw set, when offset, the outer plate allows a greater range of motion both horizontally and vertically for alignment adjustment.

In some aspects, the techniques described herein relate to the method of installing and using the strike plate [2] is placed and resides over the door adjustment strike type A [1] secured into the door adjustment inner slide [3], with two screws [5] aligning the strike plate with the door jamb cavity. Before tightening screws [5], an installer checks the alignment between the latch assembly (not shown) and latch opening (this may also include checking the alignment between a deadbolt assembly, not shown, and deadbolt opening). If the alignment is correct, then screws [5] are tightened to clamp the door adjustment inner slide against the door adjustment strike type A [1] and strike plate [2], thereby holding the adjustable strike plate in the desired position. If the alignment is not correct, then the installer adjusts the vertical and/or horizontal position of the adjustable strike plate [2] within the range of motion within the door adjustment type A [1] before tightening the screws [5]. The offset of the inner slide openings allows a greater range of motion both horizontally and vertically to address any adjustment needs.

For applications in which door frames include a pre-fabricated cavity and pre-drilled holes, the door adjustment inner slide [3] and door adjustment type A [1] are sized to fit within pre-fabricated cavities after deepening 5/16″.(inches) The heavier and more secure screws [4] will bypass the typical short screws used in the pre-drilled holes.

In addition to improving the installation and security of adjustable strike plate systems, the invention also improves maintenance associated with adjustable strike plates. For instance, buildings often settle after being built, resulting in misalignment between the adjustable strike plate [2] and the latch and/or deadbolt. Typically, this would require filing the adjustable strike itself or re-drilling holes in the doorframe to move the position of the adjustable strike. The invention allows the position of the adjustable strike plate [1], and in particular, the position of the deadbolt opening and latch opening, to be adjusted without having to re-drill holes in a door frame. Instead, screws [5] are loosened, allowing an installer to reposition the adjustable strike [2] either in the horizontal or vertical direction, depending on the misalignment, and then secure the adjustable strike plate [2] in the desired position by re-tightening screws [5]. The offset of the inner slide openings allows a greater range of motion both horizontally and vertically to address any adjustment needs.

In some aspects, the techniques described herein relate to the method of installing an adjustable striker plate apparatus including an inner plate, a middle plate, an outer plate, and two sets of screws, a first screw set and a second screw set, wherein the inner plate includes one central rectangular hollow gap, one top circular hole, and one bottom hole; wherein the middle plate includes one central rectangular hollow gap with a top and hollow bottom indentation, a top right hole, a top left hole, a bottom right hole, a bottom left hole, a right rectangular perpendicular protuberance, a top perpendicular protuberance, left perpendicular protuberance, a bottom perpendicular protuberance, these protuberances form a middle plate-cavity; wherein the outer plate includes one central rectangular hollow gap, one top circular hole, one bottom hole, and one semi-circular protuberance, wherein the three plates are placed parallel to each other, forming a central rectangular apparatus-cavity by the inner plate gap, the middle plate gap, and the outer plate gap; and wherein the apparatus is detachably attached to a door jamb of a doorframe, and the method includes of steps: (i) positioning the door adjustment inner plate on the door jamb cavity, (ii) the middle plate is placed over the inner plate and secured with four #6×1.25 wood screws, wherein the middle plate is secured non-adjustable to the door jamb over the latch and/or deadbolt cavities, (iii) the outer plate is placed and resides over the middle plate secured into the inner plate, with two screws (#6-32 screws), aligning the strike plate with the door jamb cavity, (iv) the outer plate is placed over the middle plate and the door jamb, wherein the outer plate is sized to be slightly smaller than the door jamb cavity, and (v) after proper alignment, the outer plate is secured by two #6-32 screws.

In some aspects, the techniques described herein relate to a method, wherein the inner plate attachment to the door jamb limits the positioning of a latch or deadbolt opening to the apparatus cavity.

In some aspects, the techniques described herein relate to a method, the outer plate allows vertical or horizontal adjustments over the door jamb cavity.

In some aspects, the techniques described herein relate to a method, the door jamb cavity is deepened by 5/16″(inches), and positions the inner plate into the cavity.

In some aspects, the techniques described herein relate to a method, wherein before tightening #6-32 screws, an installer ensures proper alignment between the latch assembly and latch opening.

In some aspects, the techniques described herein relate to a method, where before tightening the #6-32 screws, an installer ensures proper alignment between a deadbolt assembly and a deadbolt opening.

### Detailed Figure Description

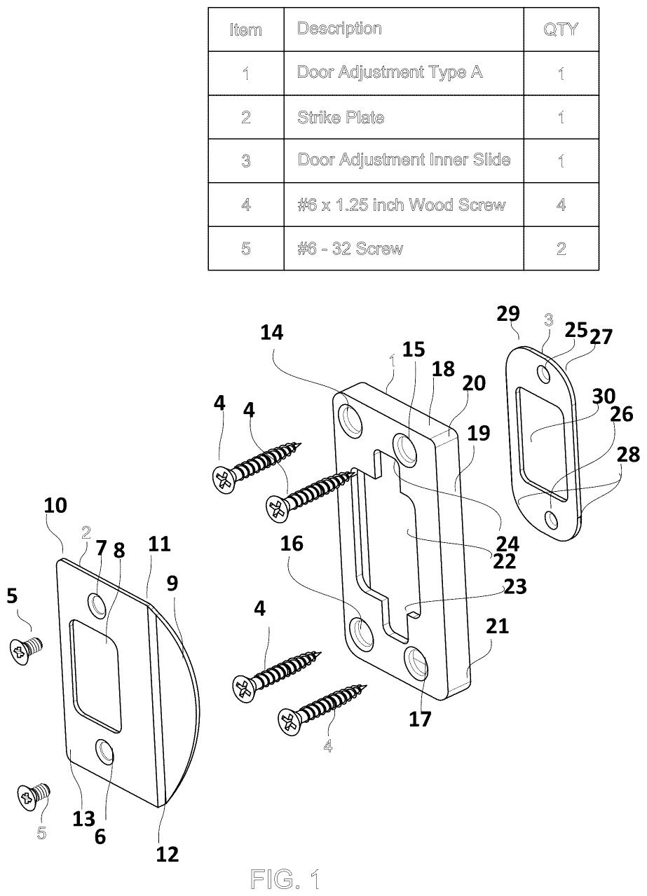

FIG. 1 is an exploded isometric view and parts identification table for the adjustable striker plate assembly. The door adjustment inner slide plate, referred to herein as the inner plate [3], is placed and resides in the strike cavity of the door jamb, and the door adjustment type A referred to herein as the middle plate [1], is secured over the slide to the door jamb with four #6×1.25 screws [4] (referred herein as first screw/s set) ensuring greater security than a typical strike plate installation. The strike plate referred to herein as the outer plate [2] is placed and resides over the door adjustment type A secured to the door adjustment inner slide [3] through the elongated holes of the door adjustment type A (1) with two #6-32 screws [5] (referend herein as the second screw/s set). The offset of the inner slide openings allows a greater range of motion both horizontally and vertically to address any adjustment needs.

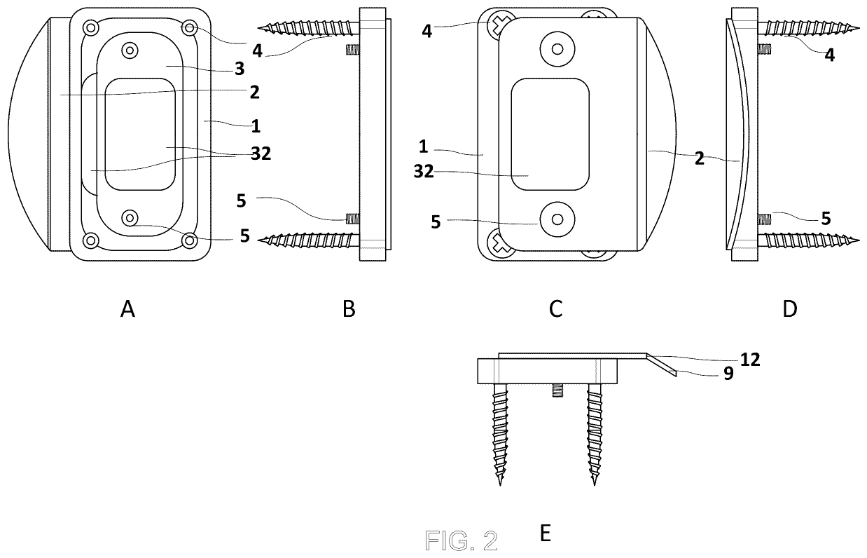

The inner plate [3], a middle plate [1], an outer plate [2], and two sets of screws, a first screw set [4] and a second screw set [5], wherein the inner plate [3] comprises one central rectangular hollow gap [30], one top circular hole [25], and one bottom hole [26]; wherein the middle plate [1] comprises one central rectangular hollow gap with a top and bottom hollow indentation, a top right hole[14], a top left hole [15], a bottom right hole [16], a bottom left hole [17], a right rectangular perpendicular protuberance (not shown), a top perpendicular protuberance [18], left perpendicular protuberance [19], a bottom perpendicular protuberance (not shown); wherein the outer plate [2] comprises of comprises one central rectangular hollow gap [8], one top circular hole [7], one bottom hole [6], and one semi-circular protuberance [9] bent towards the apparatus with an angle [12], wherein the three plates are placed parallel to each other, forming a central rectangular apparatus-cavity by the inner plate gap, the middle plate gap, and the outer plate gap in FIG. 2; and wherein the apparatus is detachably attached to a door jamb of a doorframe (not shown). The edges of each plate and/or the apparatus may be rounded or not [11], [20], and [27].

FIG. 2 is a collection of the back, [A], left [B], front [C], right [D], and bottom views [E] of the assembled adjustable striker plate. The back view illustrates the range of motion of the adjustable door inner slide [3], within the door adjustment type A [1], on all four sides, facilitating the horizontal and vertical adjustments not available in previous solution attempts. The left, right and bottom views illustrate the depth of the assembled door adjustable type A [1] behind the strike plate [2] concealing the inner slide [3], as well as the heavier security of longer wood screws into the door jamb. The adjustable striker plate is installed into a doorframe pre-fabricated door jamb cavity by increasing the depth by 5/16″ to facilitate the deeper door adjustable type A [1] and adjustable door inner slide [3] assembly. The front view illustrates the range of motion of the strike plate [2] on the face of the door adjustment type A [1], part of the adjustable striker plate. The offset of the inner slide openings allows a greater range of motion both horizontally and vertically to address any adjustment needs. The back and front views show the apparatus cavity formed by the inner plate gap, the middle plate gap, and the outer plate gap [32]. The bottom view shows that the semi-circular protuberance [9] is bent towards the inner parts of the apparatus.

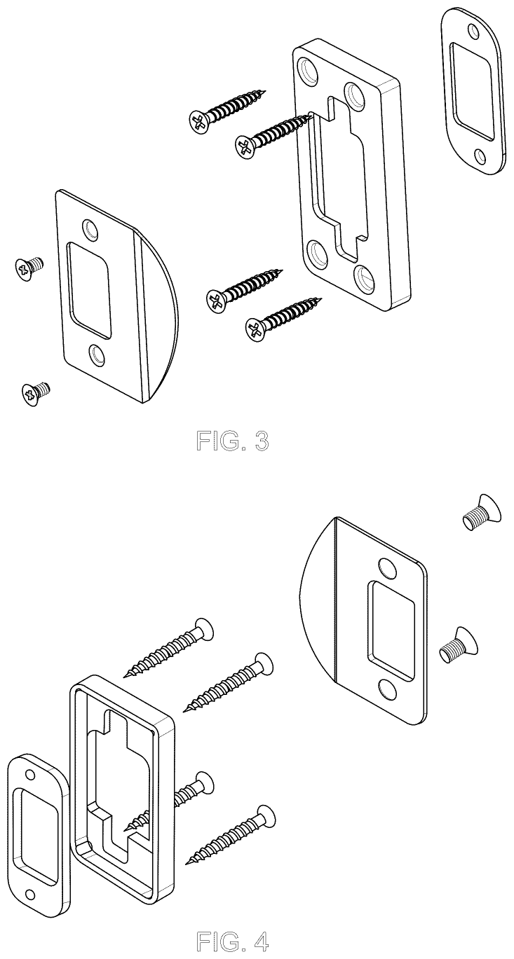

FIG. 3 is an exploded isometric front view of the adjustable striker plate assembly. The door adjustment inner slide [3] is placed and resides in the strike cavity of the door jamb, and the door adjustment type A [1] is secured over the slide to the door jamb with four #6×1.25 screws, the first screw set, ensuring greater security than a typical strike plate installation. The illustration illustrates the range of motion of the strike plate [2], both vertically and horizontally through the face of the door adjustment type A [1] into the door adjustment inner slide [3]. A benefit of this design is the adjustable striker plate is reversible (i.e., it may be mounted on either side of a doorframe). The door adjustment type A [1] and strike plate [2] may be mounted on the right side of a door frame in the current orientation or may be flipped end-for-end and mounted on the left side of a door frame.

FIG. 4 is an exploded isometric rear view of the adjustable striker plate assembly. The door adjustment inner slide [3] is placed and resides in the strike cavity of the door jamb, and the door adjustment type A [1] is secured over the slide to the door jamb with four #6×1.25 screws, the first screw set, ensuring greater security than a typical strike plate installation. The illustration illustrates the range of motion of the inner slide [3], both horizontally and vertically, within the rear of the door adjustment type A [1]. The offset of the inner slide openings allows a greater range of motion both horizontally and vertically to address any adjustment needs.

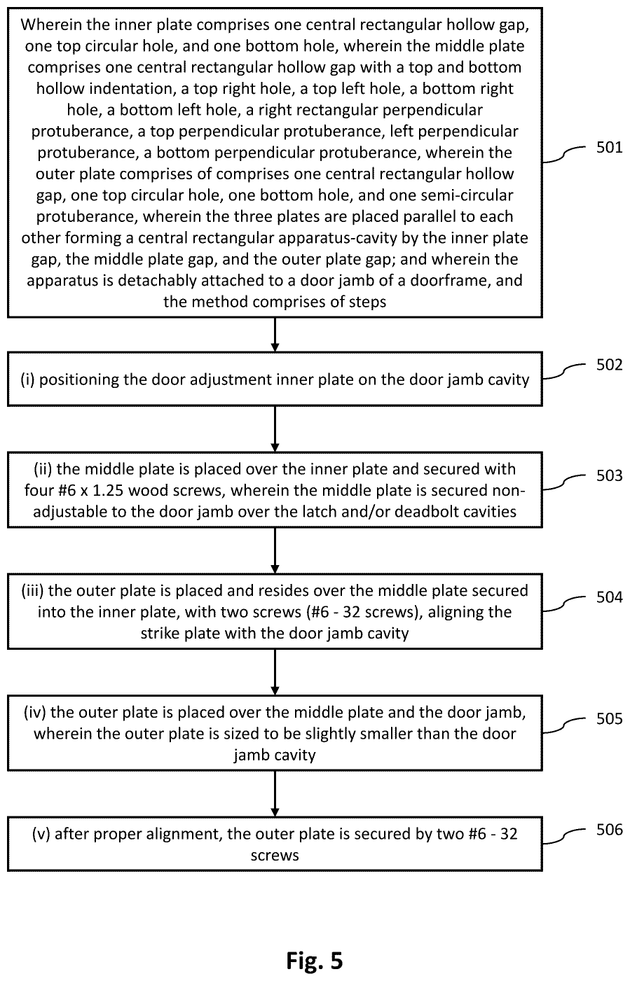

FIG. 5 is a flowchart of an example method for installing and using an adjustable striker plate apparatus comprising an inner plate, a middle plate, an outer plate, and two sets of screws, a first screw set and a second screw set, wherein the inner plate comprises one central rectangular hollow gap, one top circular hole, and one bottom hole, wherein the middle plate comprises one central rectangular hollow gap with a top and bottom hollow indentation, a top right hole, a top left hole, a bottom right hole, a bottom left hole, a right rectangular perpendicular protuberance, a top perpendicular protuberance, left perpendicular protuberance, a bottom perpendicular protuberance, wherein the outer plate comprises of comprises one central rectangular hollow gap, one top circular hole, one bottom hole, and one semi-circular protuberance, wherein the three plates are placed parallel to each other forming a central rectangular apparatus-cavity by the inner plate gap, the middle plate gap, and the outer plate gap; and wherein the apparatus is detachably attached to a door jamb of a doorframe [501], and the method comprises of steps:

At step 502, (i) positioning the door adjustment inner plate on the door jamb cavity,

At step 503, (ii) the middle plate is placed over the inner plate and secured with four #6×1.25 wood screws, the first screw set, wherein the middle plate is secured non-adjustable to the door jamb over the latch and/or deadbolt cavities,

At step 504, (iii) the outer plate is placed and resides over the middle plate secured into the inner plate, with two screws #6-32 screws, the second screw set, aligning the strike plate with the door jamb cavity.

At step 505, (iv) the outer plate is placed over the middle plate and the door jamb, wherein the outer plate is sized to be slightly smaller than the door jamb cavity, and

At step 506, (v) after proper alignment, the outer plate is secured by two #6-32 screws, the second screw set.

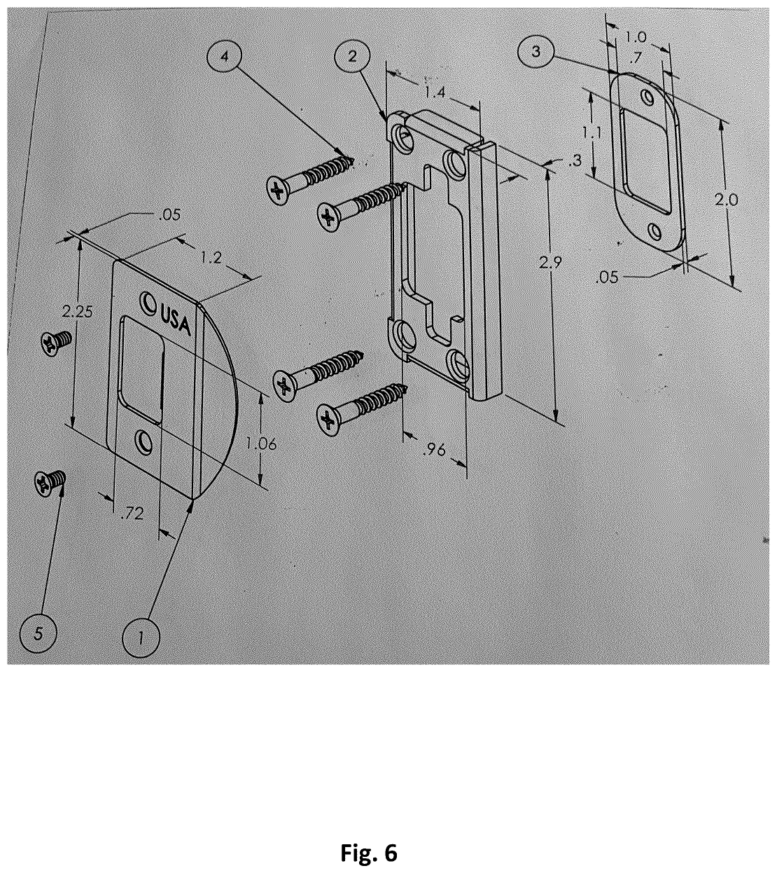

FIG. 6 is an exploded isometric view with dimensions for the apparatus parts. All the measurements are in inches and represent one embodiment to fit a conventional or industry-standard door jamb and lock assembly. It is understood that other dimensions may be possible for other latch or deadbolt and door jamb arrangements using the same structural elements of this disclosure.

It is to be understood that the above description is intended to be illustrative and not restrictive. For example, the above-described embodiments (and/or aspects thereof) may be used in combination with each other. In addition, many modifications may be made to adapt a particular situation, method, system device or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

We claim:

1) An adjustable striker plate apparatus comprising an inner plate, a middle plate, an outer plate, and two sets of screws, a first screw set and a second screw set,
wherein the inner plate comprises one central rectangular hollow gap, one top circular hole, and one bottom hole;
wherein the middle plate comprises one central rectangular hollow gap with a top and bottom hollow indentation, a top right hole, a top left hole, a bottom right hole, a bottom left hole, a right rectangular perpendicular protuberance, a top perpendicular protuberance, left perpendicular protuberance, a bottom perpendicular protuberance;
wherein the outer plate comprises of comprises one central rectangular hollow gap, one top circular hole, one bottom hole, and one semi-circular protuberance,
wherein the three plates are placed parallel to each other, forming a central rectangular apparatus-cavity by the inner plate gap, the middle plate gap, and the outer plate gap; and
wherein the apparatus is detachably attached to a door jamb of a doorframe.

2) The apparatus of claim 1, wherein the inner plate is placed next to the door jamb, the middle plate is sandwiched between the inner plate and the outer plate, and the outer plate is placed and resides over the middle plate.

3) The apparatus of claim 1, wherein the middle plate is secured over the inner to the door jamb with the first screw set comprising of four #6×1.25 screws.

4) The apparatus of claim 1, wherein the first screw set comprises four #6×1.25 screws, and wherein the four screws fit into the four corners of the middle plate.

5) In the apparatus of claim 1, wherein the first screw set ensures greater security and stability compared to a typical strike plate installation.

6) The apparatus of claim 1, wherein the outer plate is placed and resides over the middle plate through the holes of the middle plate with the second screw set comprising two #6-32 screws.

7) In the apparatus of claim 1, wherein the two screws from the second screw set, when offset, the outer plate allows a greater range of motion both horizontally and vertically for alignment adjustment.

8) In the apparatus of claim 1, the middle plate and the outer plate conceal the inner plate.

9) In an apparatus of claim 1, the first screw set is longer wood screws into the door jamb for heavier and stronger security.

10) In an apparatus of claim 1, the apparatus is installed into a doorframe pre-fabricated cavity by increasing the depth by 5/16 inches to facilitate the deeper middle plate and adjustable inner plate assembly.

11) In an apparatus of claim 1, the apparatus is reversible and is mountable on either side of the doorframe.

12) The apparatus of claim 1, where the apparatus is substitutable for a conventional strike plate.

13) The apparatus of claim 1, wherein the apparatus is a replacement for any conventional latch plate.

14) The apparatus of claim 1, wherein the apparatus is a replacement for any conventional deadbolt plate.

15) The method of installing an adjustable striker plate apparatus comprising an inner plate, a middle plate, an outer plate, and two sets of screws, a first screw set and a second screw set,
wherein the inner plate comprises one central rectangular hollow gap, one top circular hole, and one bottom hole;
wherein the middle plate comprises one central rectangular hollow gap with a top and bottom hollow indentation, a top right hole, a top left hole, a bottom right hole, a bottom left hole, a right rectangular perpendicular protuberance, a top perpendicular protuberance, left perpendicular protuberance, a bottom perpendicular protuberance;
wherein the outer plate comprises of comprises one central rectangular hollow gap, one top circular hole, one bottom hole, and one semi-circular protuberance,
wherein the three plates are placed parallel to each other forming a central rectangular apparatus-cavity by the inner plate gap, the middle plate gap, and the outer plate gap; and
wherein the apparatus is detachably attached to a door jamb of a doorframe, and the method comprises of steps:
i) positioning the door adjustment inner plate on the door jamb cavity,
ii) the middle plate is placed over the inner plate and secured with four #6×1.25 wood screws, wherein the middle plate is secured non-adjustable to the door jamb over the latch and/or deadbolt cavities,
iii) the outer plate is placed and resides over the middle plate secured into the inner plate, with two #6-32 screws, aligning the strike plate with the door jamb cavity,
iv) the outer plate is placed over the middle plate and the door jamb, wherein the outer plate is sized to be slightly smaller than the door jamb cavity, and
v) after proper alignment, the outer plate is secured by two #6-32 screws.

16) The method of claim 15, wherein the inner plate attachment to the door jamb limits the positioning of a latch or deadbolt opening to the apparatus cavity.

17) The method of claim 15, the outer plate allows vertical or horizontal adjustments over the door jamb cavity.

18) The method of claim 15, the door jamb cavity is deepened by 5/16 inches and positions the inner plate into the cavity.

19) The method of claim 15, wherein before tightening #6-32 screws, an installer ensures proper alignment between the latch assembly and latch opening.

20) The method of claim 15, where before tightening the #6-32 screws, an installer ensures proper alignment between a deadbolt assembly and a deadbolt opening.
